(19) United States
(12) Patent Application Publication
(10) Pub. No.: US 2025/0190602 A1
(43) Pub. Date: Jun. 12, 2025

(54) PRIVACY-PRESERVING GRAPH ANALYTICS ON HYBRID CLOUD ENVIRONMENTS

(71) Applicant: International Business Machines Corporation, Armonk, NY (US)

(72) Inventors: Vasileios Kalantzis, White Plains, NY (US); Lior Horesh, North Salem, NY (US); Shashanka Ubaru, Ossining, NY (US); Georgios Kollias, White Plains, NY (US)

(21) Appl. No.: 18/533,389

(22) Filed: Dec. 8, 2023

(51) Int. Cl. G06F 21/62

(52) U.S. Cl. CPC G06F 21/6218

(57) ABSTRACT

A method for preserving privacy by counting triangles on a graph G for hybrid cloud environments includes partitioning data elements of the graph G into a plurality of non-overlapping subgraphs, modifying each of the plurality of non-overlapping subgraphs to generate a plurality of p-induced subgraphs, distributing each of the plurality of p-induced subgraphs to a separate server located on a public cloud environment, computing a resultant number of triangles (p-integer) associated with each of the p-induced subgraphs for each of the separate servers located on the public cloud environment and computing a final number of triangles associated with the resultant number of triangles (p-integer) via an on-premise server.

### BACKGROUND

The present invention generally relates to a method for counting triangles on a graph, and more specifically, to a method for preserving privacy by counting triangles on a graph for hybrid cloud environments.

Triangle counting in graph mining is a data analysis technique that is widely used in social network analysis, recommendation systems and other complex fields. Accordingly, triangle counting is used to address important problems in the field of graph mining. For example, triangle counting is a critical parameter in mining relationships among people in social network analysis. Unfortunately, counting the number of triangles in a graph is a fundamental problem with numerous applications. This is because counting triangles is a special case of (a) counting given length cycles, (b) counting complete subgraphs of given size or (c) certain other small subgraphs, called motifs. One such problem with triangle counting is that triangle counts may create privacy concerns like breaching edge privacy, such as sensitive relations between individuals.

### SUMMARY

A method for preserving privacy by counting triangles on a graph for hybrid cloud environments is provided and includes partitioning data elements of a graph G into a plurality of non-overlapping subgraphs, distributing each of the plurality of non-overlapping subgraphs to a separate server located on a public cloud environment, augmenting each of the plurality of non-overlapping subgraphs with new vertices and random edge connections to create p-induced subgraphs, computing a resultant number of triangles (p-integer) associated with each of the plurality of non-overlapping subgraphs for each of the servers located on the public cloud environment, transmitting the p-integer to an on-premise server and computing a final number of triangles associated with subgraphs formed by coupling the p-induced subgraphs via the on-premise server by adding the p-integer to the number of triangles associated with the subgraphs formed by the coupling of the p-induced subgraphs and subtracting a number of triangles that have at least one added edge connection to previously added random edge connections.

Embodiments of the invention are also directed to computer-implemented methods and computer program products having substantially the same features and functionality as the computer system described above.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows a block diagram of an example computer system for use in accordance with one or more embodiments of the present invention;

FIG. 2 is an operational block diagram illustrating a method for preserving privacy by counting triangles on a graph for hybrid cloud environments, in accordance with one or more embodiments of the present invention;

FIG. 3 is a graphic showing the interconnection of servers via the plurality of triangles and vertices in a public-private hybrid cloud connection, in accordance with one or more embodiments of the present invention; and

FIG. 4 is a graphic showing the augmentation of the subgraphs with a set of new vertices and random edge connections, in accordance with one or more embodiments of the present invention.

### DETAILED DESCRIPTION

As discussed briefly above, the present invention relates to a method for counting triangles on a graph for hybrid cloud environments while preserving the privacy of the graph analytics.

It should be appreciated that counting the number of triangles in a graph is a fundamental problem with numerous applications. This is because counting triangles is a special case of (a) counting given length cycles, (b) counting complete subgraphs of given size and/or (c) certain other small subgraphs, called motifs. More importantly, counting triangles is a basic issue in network analysis. One important application involves the fact that high clustering coefficients signal “tightly knit communities” of a group of people such that most pairs with a mutual friend are themselves friends. Such communities are expected to have interesting properties, like unusually high degrees of “trust” where there is a strong disincentive to doing anything wrong to someone you are connected to, since lots of your other friends are likely to hear about it. Another important reason involves the fact that a low clustering coefficient can signal a “structural hole” which includes a vertex that is well connected to different communities but that are not otherwise connected to each other. Such a vertex is in a potentially advantageous situation, for example, to combine two different skill sets to produce innovations, or at least to transfer ideas from one community to another.

Protecting edge privacy (and other privacy concerns) in triangle counting is a challenging problem due to the strong correlation among data from different clients, especially when the triangle counting involves hybrid and cloud environments. It is furthermore challenging to provide a definitive solution to current issues since there are hundreds, if not thousands, of algorithms available to choose from to solve these issues, and these algorithms are broadly classified in exact methods (i.e., computing the exact number of triangles) or approximate methods (i.e., computing an estimate that it is 90%-95% accurate, but faster). In an embodiment, the method of the invention focuses on the first category, the method can be modified to provide an approximate answer, thereby achieving this complexity as well. The method of the invention uses a new procedure that avoids the use of costly privacy mechanisms by dealing with eavesdropping at a numerical level. In other words, the approach of the method is not to provide a scheme that is faster than current algorithms, but rather to provide a method that is expected to require far fewer resources to complete its task exactly because a hybrid cloud environment is assumed. Accordingly, due to erroneous vertices that are added, an eavesdropper will never really know which data is correct and which data is superficial, even if an eavesdropping recovers some data from one of the servers (assuming there are multiple such servers).

Accordingly, an embodiment of the method exploits public cloud resources to perform parallel tasks which represent the main bulk of the overall computational complexity, where a private cloud environment is used to perform the remaining tasks. This method introduces at least two advantages: a) the exact number of triangles is never communicated outside of the private cloud environment, and b) tasks that are performed on the private cloud environment are tasks that do not parallelize as well, thus instead of spending time and money communicating data to servers, the on-premise processing power is leveraged. It should be appreciated that the method of the invention assumes a hybrid cloud environment, where all data are stored on-premise (i.e., not decentralized) and only a portion of the data is transferred to outside servers (i.e., public servers) for parallel computations. Additionally, the method assumes that after the parallel computations on the data that was transferred to the outside servers has been competed, all of the data is erased. Also, in order to secure the data being transferred, the method further introduces a portion of dummy vertices and connections on top of the standard encryption. In an embodiment, the method essentially splits the data and creates parallel subtasks on public and private servers.

Consider the situation where a triangle is a set of three vertices such that any two of the vertices are connected by an edge of graph G (3-clique) and the matrix A ∈ {0, 1} ^{n×n} is the corresponding adjacency matrix, where nnz (A) denotes the number of nonzero entities (i.e., edges). Thus, the number of triangles in graph G is given by ⅙tr(A³)=⅙Σᵢ₌₁ⁿAᵤ³. In this case then, the fastest exact algorithm runs at O(nnz(A)^{1.41}) (AYZ) and practical alternatives run at O(nnz(A)^{1.5}), e.g., NodeIterator. In counting triangles, some key graph quantities include a “clustering coefficient” and “transitivity”, where the clustering coefficient is a measure of the degree to which vertices in a graph tend to cluster together. For example, a clustering coefficient of a vertex v is given by: C(v):=Δ(v)/(#of triplets involving v), where Δ(v) is equal to the number of triangles the vertex v participates in. Transitivity is the overall probability for the network to have adjacent nodes that are interconnected, thereby revealing the existence of tightly connected communities (or clusters, subgroups, cliques). Accordingly, the Transitivity Ratio is given by: T:=(3*number of triangles)/(#of all triplets).

It should be appreciated that one issue that can be addressed involves the creation of marketing opportunities. Because a high Transitivity Ratio implies similarity between nodes, marketing opportunities in e-commerce platforms (for example, suggest to user i what you suggested to users j and k if they form a triangle) can be created by computing the Transitivity Ratio. Another issue involves community detection (i.e., identifying clusters of vertices) by finding neighboring vertices with high triangle participation.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as for solving a contextual bandit problem having a trending reward function 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

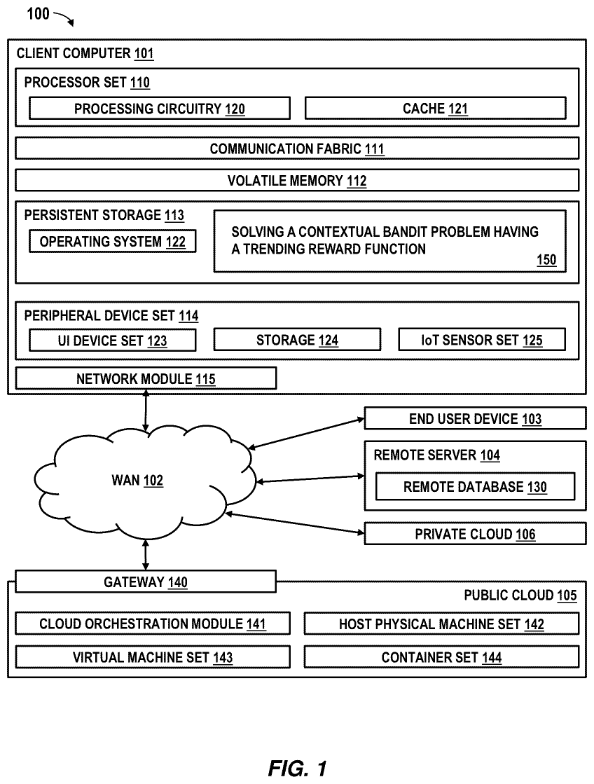

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

It should be appreciated that due to the massive size of modern networks, counting the number of triangles of the associated graph required distributed memory computing. In an embodiment, the method of the invention considers an asynchronous system which counts triangles in hybrid cloud environments. In particular, the method employs a hybrid-cloud approach which splits the computation into two different parts: 1) one part computed in a public cloud environment, and 2) one part computed in a private cloud environment. In addition to speeding-up execution, the method keeps the exact number of triangles hidden from adversarial attacks, even if the data encryption protocol is compromised. As counting triangles of large graphs can be very time-consuming, the total number of triangles can be computed faster by decomposing the original graph into p ∈Z partitions, thereby applying a divide-and-conquer approach.

For example, consider the situation where the reordered adjacency matrix of the partitioned graph can be written as:

$$A = ( \begin{matrix}B 1 & & … & & E 1 \\ & B 2 & & {}_{}^{} & E 2 \\ ⋮ & & ⋱ & & ⋮ \\ & & & {B}_{p} & {E}_{p} \\ {E}_{1}^{T} & {E}_{2}^{T} & … & {E}_{p}^{T} & C\end{matrix} ) = ( \begin{matrix}B & E \\ {E}^{T} & C\end{matrix} ) ,$$

thus, the number of triangles is then equal to Δ=tr(A³)/6=Σⱼ₌₁^{j=n}(A³)ⱼⱼ/6. Applying a straightforward computation would give the following:

$$A 3 = ( \begin{matrix}{B}^{3} + {EE}^{T} B + {BEE}^{T} + {ECE}^{T} & * \\ * & {C}^{3} + {E}^{T} + {CE}^{T} E + {E}^{T} EC\end{matrix} ) .$$

Noticing that tr(ECE^{T})=tr(E^{T}EC)=tr(CE^{T}E), and tr(BEE^{T})=tr(EE^{T}B)=tr(E^{T}BE) leads to tr(A³)=tr(C³)+tr(B³)+3 [tr(ECE^{T})+tr(E^{T}BE)]. And, due to the block partitioning of matrix B, this results in tr(B³)=tr(B₁³)+tr(B₂³)+ . . . +tr(Bₚ³), tr(E^{T}BE)=tr(E₁^{T}B₁E₁)+tr(E₂^{T}B₂E₂)+ . . . +tr(Eₚ^{T}BₚEₚ). Accordingly, it can be seen that p number of independent servers on a public cloud environment are computed by computing tr(B³) and that these p trace terms are computed in a parallel fashion. It can also be seen that tr(E^{T}BE), tr(C³) and tr(ECE^{T}) are computed on a private (on-premise) cloud environment. Therefore, the matrix traces can be computed by any appropriate triangle counting algorithm. One option is to use graph-based algorithms with cost O(m^{3/2}), where m denotes the number of non-zero entries. Another option is to apply stochastic trace estimation.

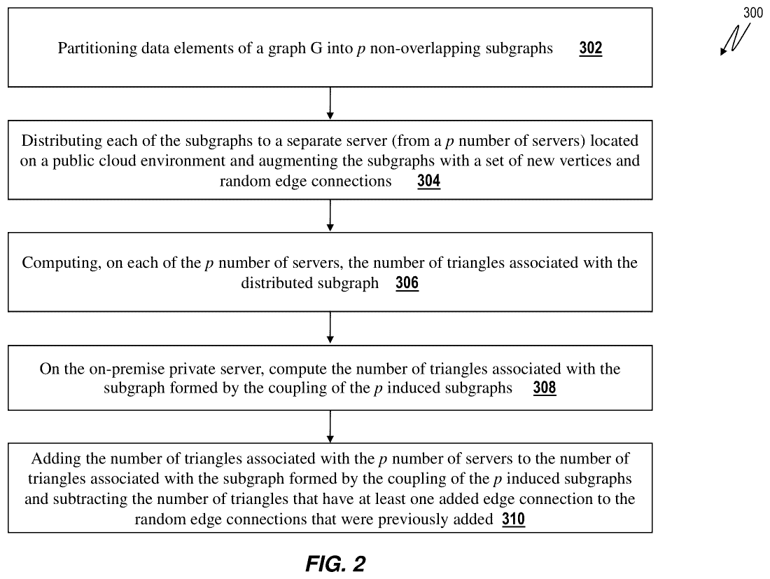

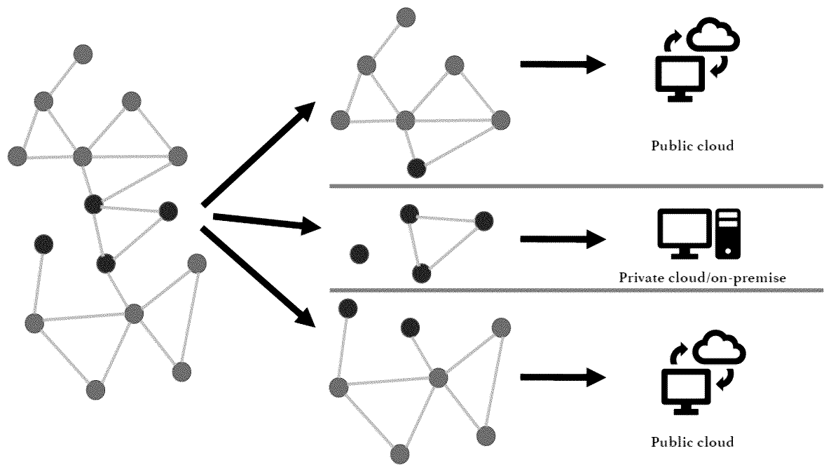

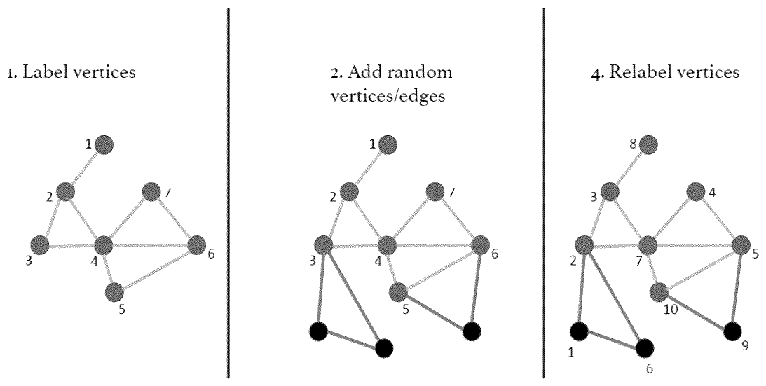

In accordance with an embodiment, a method 300 for preserving privacy by counting triangles on a graph for hybrid cloud environments is provided, as shown in FIG. 2. The method 300 includes partitioning the data elements of a graph G into p non-overlapping subgraphs, as shown in operational block 302. Referring to FIG. 3, this may be accomplished by partitioning the data elements of the graph G into subgraphs based upon predefined parameters which separate the data elements in the graph from each other. Referring to FIG. 4, the method 300 includes distributing each of the subgraphs to a separate server (from a p number of servers) located on a public cloud environment, as shown in operational block 304, wherein each of the subgraphs are augmented with a set of new vertices and added random edge connections. The method 300 includes computing, on each of the p number of servers, the number of triangles associated with the distributed subgraph, as shown in operational block 306. At this point, the resultant number of triangles (i.e., p integer) are then transmitted back to the on-premise (i.e., private) server.

The method 300 also includes computing, on the on-premise server, the number of triangles associated with the subgraph formed by the coupling of the p induced subgraphs, as shown in operational block 308. The method 300 includes adding the number of triangles associated with the p number of servers to the number of triangles associated with the subgraph formed by the coupling of the p induced subgraphs and subtracting the number of triangles that have at least one added edge connection to random edge connections that were previously added, as shown in operational block 310.

It should be appreciated that method 300 preserves the privacy of the data by applying a first layer of security and a second layer of security. The first layer of security involves the hybrid cloud environment where the total number of triangles is equal to 4=Δ_{public}+Δₚᵣᵢᵥₐₜₑ. Therefore, it is generally impossible to intercept Δ, as long as the private cloud Δₚᵣᵢᵥₐₜₑ is secure. However, an eavesdropper could potentially intercept the public cloud Δ_{public} and the matrix Bj. The second layer of security therefore involves applying redundant and random data. In order to address the issue of eavesdropper interception, the method 300 augments the matrix Bj by introducing a random number of dummy vertices and random connections between these newly introduced vertices with the actual vertices of the j-th partitions. These quantities are then transferred to the public cloud which computes the resultant number of triangles \hat{Δ}_{public} and returns the computed resultant number of triangles \hat{Δ}_{public} to the private cloud. And while \hat{Δ}_{public}>Δ_{public}, the private cloud knows the exact difference between \hat{Δ}_{public} and Δ_{public} (i.e., \hat{Δ}_{public}−Δ_{public}). Accordingly, the private cloud computes the exact value of Δ.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

What is claimed is:

1. A method for preserving privacy by counting triangles on a graph G for hybrid cloud environments, the method comprising:
partitioning data elements of the graph G into a plurality of non-overlapping subgraphs;
modifying each of the plurality of non-overlapping subgraphs to generate a plurality of p-induced subgraphs;
distributing each of the plurality of p-induced subgraphs to a separate server located on a public cloud environment;
computing a resultant number of triangles (p-integer) associated with each of the p-induced subgraphs for the separate server located on the public cloud environment; and
computing a final number of triangles associated with the resultant number of triangles (p-integer) via an on-premise server.

2. The method of claim 1, wherein partitioning includes partitioning the data elements responsive to a set of graph parameters.

3. The method of claim 2, wherein the graph parameters include at least one of a clustering coefficient and a transitivity ratio.

4. The method of claim 1, wherein distributing includes augmenting each of the plurality of non-overlapping subgraphs with at least one of a set of new vertices and random edge connections.

5. The method of claim 1, further comprising transmitting the resultant number of triangles (p-integer) to the on-premise server.

6. The method of claim 1, wherein computing a final number of triangles includes,
adding the p-integer to the number of triangles associated with the p-induced subgraphs to create a semi-final number of triangles, and
subtracting a number of triangles that have at least one added edge connection to previously added random edge connections from the semi-final number of triangles.

7. A method for preserving privacy by counting triangles on a graph for hybrid cloud environments, the method comprising:
partitioning data elements of a graph G into a plurality of non-overlapping subgraphs;
distributing each of the plurality of non-overlapping subgraphs to a separate server located on a public cloud environment;
augmenting each of the plurality of non-overlapping subgraphs with new vertices and random edge connections to create p-induced subgraphs;
computing a resultant number of triangles (p-integer) associated with each of the plurality of non-overlapping subgraphs for each of the servers located on the public cloud environment;
transmitting the p-integer to an on-premise server; and
computing a final number of triangles associated with subgraphs formed by coupling the p-induced subgraphs via the on-premise server by adding the p-integer to a number of triangles associated with the subgraphs formed by coupling the p-induced subgraphs and subtracting a number of triangles that have at least one added edge connection to previously added random edge connections.

8. The method of claim 7, wherein partitioning includes partitioning the data elements responsive to a set of graph parameters.

9. The method of claim 8, wherein the graph parameters include at least one of a clustering coefficient and a transitivity ratio.

10. The method of claim 7, wherein distributing includes augmenting each of the plurality of non-overlapping subgraphs with at least one of a set of new vertices and random edge connections.

11. A computing system, comprising:
a machine learning system for implementing a method for preserving privacy by counting triangles on a graph G for hybrid cloud environments, the system configured to:
partition data elements of the graph G into a plurality of non-overlapping subgraphs;
modify each of the plurality of non-overlapping subgraphs to generate a plurality of p-induced subgraphs;
distribute each of the plurality of p-induced subgraphs to a separate server located on a public cloud environment;
compute a resultant number of triangles (p-integer) associated with each of the p-induced subgraphs for the separate server located on the public cloud environment; and
compute a final number of triangles associated with the resultant number of triangles (p-integer) via an on-premise server.

12. The computing system of claim 11, wherein partitioning includes partitioning the data elements responsive to a set of graph parameters.

13. The computing system of claim 12, wherein the graph parameters include at least one of a clustering coefficient and a transitivity ratio.

14. The computing system of claim 11, wherein distributing includes augmenting each of the plurality of non-overlapping subgraphs with at least one of a set of new vertices and random edge connections.

15. The computing system of claim 11, further comprising transmitting the resultant number of triangles (p-integer) to the on-premise server.

16. The computing system of claim 11, wherein computing a final number of triangles includes,
adding the p-integer to the number of triangles associated with the p-induced subgraphs to create a semi-final number of triangles, and
subtracting a number of triangles that have at least one added edge connection to previously added random edge connections from the semi-final number of triangles.

17. A computer program product comprising a computer readable storage medium having program instructions embodied therewith, the program instructions executable by a processor to cause the processor to perform operations for implementing a method for preserving privacy by counting triangles on a graph G for hybrid cloud environments, the method comprising:
partitioning data elements of the graph G into a plurality of non-overlapping subgraphs;
modifying each of the plurality of non-overlapping subgraphs to generate a plurality of p-induced subgraphs;
distributing each of the plurality of p-induced subgraphs to a separate server located on a public cloud environment;
computing a resultant number of triangles (p-integer) associated with each of the p-induced subgraphs for each of the separate servers located on the public cloud environment; and
computing a final number of triangles associated with the resultant number of triangles (p-integer) via an on-premise server, wherein computing a final number of triangles includes,
adding the p-integer to a number of triangles associated with the p-induced subgraphs to create a semi-final number of triangles, and
subtracting a number of triangles that have at least one added edge connection to previously added random edge connections from the semi-final number of triangles.

18. The method of claim 17, wherein partitioning includes partitioning the data elements responsive to a set of graph parameters.

19. The method of claim 18, wherein the graph parameters includes at least one of a clustering coefficient and a transitivity ratio.

20. The method of claim 17, wherein distributing includes augmenting each of the plurality of non-overlapping subgraphs with at least one of a set of new vertices and random edge connections.

21. The method of claim 17, further comprising transmitting the resultant number of triangles (p-integer) to the on-premise server.

22. A system comprising:
a memory having computer readable instructions for implementing a method for preserving privacy by counting triangles on a graph G for hybrid cloud environments; and
one or more processors for executing the computer readable instructions, the computer readable instructions controlling the one or more processors to perform operations comprising:
partitioning data elements of the graph G into a plurality of non-overlapping subgraphs;
modifying each of the plurality of non-overlapping subgraphs to generate a plurality of p-induced subgraphs;
distributing each of the plurality of p-induced subgraphs to a separate server located on a public cloud environment;
computing a resultant number of triangles (p-integer) associated with each of the p-induced subgraphs for the separate server located on the public cloud environment; and
computing a final number of triangles associated with the resultant number of triangles (p-integer) via an on-premise server.

23. The system of claim 22, wherein partitioning includes partitioning the data elements responsive to a set of graph parameters, wherein the graph parameters include at least one of a clustering coefficient and a transitivity ratio.

24. The system of claim 22, wherein distributing includes augmenting each of the plurality of non-overlapping subgraphs with at least one of a set of new vertices and random edge connections.

25. The system of claim 22, wherein computing a final number of triangles includes,
adding the p-integer to the number of triangles associated with the p-induced subgraphs to create a semi-final number of triangles, and
subtracting a number of triangles that have at least one added edge connection to previously added random edge connections from the semi-final number of triangles.
